(19) United States
(12) Patent Application Publication
(10) Pub. No.: US 2017/0121084 A1
(43) Pub. Date: May 4, 2017

(54) APPARATUS, SYSTEM, AND METHOD FOR DELIVERING REFILL LIQUID TO A DESTINATION CONTAINER

(71) Applicant: My Replenishment Inc., Chilliwack (CA)

(72) Inventor: Ashley Andrew MOOREHOUSE, Chilliwack (CA)

(21) Appl. No.: 15/314,186

(22) PCT Filed: May 29, 2014
(86) PCT No.: PCT/CA2014/000465

§ 371 Date: Nov. 28, 2016

(51) Int. Cl. B65D 75/58; B65D 41/04; B65D 75/00; B67D 7/02; B65D 55/16; B65B 3/12; A45D 34/00; B65D 35/44; B65B 3/04

(52) U.S. Cl. CPC B65D 75/5883; B65D 35/44; B65D 41/04; B65D 75/008; B65B 3/045; B65D 55/16; B65B 3/12; A45D 34/00; B67D 7/0216; B67D 7/0288

(57) ABSTRACT

An apparatus for delivering refill liquid to a destination container is disclosed. The apparatus includes a deformable transport container having an opening for receiving the refill liquid and an adaptor including an inlet, an outlet, and a passage extending between the inlet and the outlet. The inlet is removably receivable at the opening of the transport container such that when the inlet is received at the opening, the inlet is operable to receive a flow of the refill liquid through the opening from the transport container and to channel the flow through the passage to the outlet, the outlet being operable to dispense the refill liquid into the destination container, and when the inlet is not received at the opening, the transport container is operable to receive the refill liquid through the opening. Systems and methods for delivering refill liquid to a destination container are also disclosed.

### BACKGROUND OF THE INVENTION

1. Field of Invention

This invention relates to refillable containers and more particularly to an apparatus, system, and method for delivering refill liquid to a destination container.

2. Description of Related Art

Containers used for carrying and dispensing liquids such as personal care or cosmetic products, for example, are not generally intended to be refilled. Such containers may be expensive to make and may include rigid or semi rigid bodies that are ergonomically designed for users. Once empty, such containers are often thrown away and a user is required to purchase a new container, in order to obtain additional product. This wastage of empty containers may result in both financial and environmental costs.

It may be desirable to refill such containers such that they may be used numerous times before a user is required to purchase a new container. One method of refilling containers involves the use of a transport container. However, conventional transport containers have various problems. For example, conventional transport containers may be expensive to make or difficult to use. For example, conventional transport containers may be difficult to fill or difficult to empty or dispense from.

### SUMMARY OF THE INVENTION

In accordance with one aspect of the invention, there is provided an apparatus for delivering refill liquid to a destination container. The apparatus includes a deformable transport container having an opening for receiving the refill liquid, and an adaptor including an inlet, an outlet, and a passage extending between the inlet and the outlet. The inlet is removably receivable at the opening of the transport container such that when the inlet is received at the opening, the inlet is operable to receive a flow of the refill liquid through the opening from the transport container and to channel the flow through the passage to the outlet, the outlet being operable to dispense the refill liquid into the destination container, and when the inlet is not received at the opening, the transport container is operable to receive the refill liquid through the opening.

The apparatus may further include a retainer coupled between the adaptor and the transport container for retaining the adaptor with the transport container.

The retainer may include a flexible strap.

The flexible strap may be rotatably coupled to the transport container such that the adaptor is free to rotate about the opening.

The inlet may be removably receivable within the opening of the transport container.

The inlet may include a taper complementary to the opening of the transport container such that the inlet, when received in the opening, is retained by a friction fit between the inlet and the transport container.

The inlet may include a threaded portion and the transport container may include a threaded portion complementary to the threaded portion of the inlet, the threaded portion of the transport container being configured to threadably receive the inlet at the opening.

The adaptor may further include a flange adjacent the inlet and disposed to abut at least a portion of the transport container when the inlet is received at the opening of the transport container.

The flange may include a ring encircling the passage.

The outlet may be removably receivable in the opening of the destination container.

The outlet may be configured to form a gap between the outlet and the destination container at the opening of the destination container when the outlet is received in the opening of the destination container.

The adaptor may further include a flange adjacent the outlet and disposed to abut at least a portion of the destination container at the opening of the destination container when the outlet is received in the opening of the destination container.

The outlet may include a frustoconical portion.

The outlet may include a cylindrical portion extending from the frustoconical portion.

The transport container may be configured to receive a closure for closing the opening.

The closure may include a cap.

The cap may include a threaded portion and the transport container may include a complementary threaded portion for threadably receiving the cap.

The transport container may include a plastic bag.

The refill liquid may include a personal care product.

The personal care product may include soap, shampoo, conditioner, or lotion.

A system for delivering refill liquid may include any one of the above apparatuses, and the destination container.

The destination container may include a personal care product container.

The personal care product container may be operable to hold the refill liquid.

In accordance with another aspect of the invention, there is provided a method of delivering refill liquid to a destination container. The method involves receiving the refill liquid in a deformable transport container through an opening of the transport container, configuring the transport container for transport by closing the opening of the transport container, and configuring the transport container to receive an inlet of an adaptor at the opening by opening the opening. The method also involves removably receiving the inlet of the adaptor at the opening of the transport container, receiving an outlet of the adaptor at an opening of the destination container, and causing the refill liquid to flow from the opening of the transport container through a passage extending from the inlet to the outlet of the adaptor to dispense the refill liquid into the destination container.

The method may further involve removing the inlet from the opening of the transport container and retaining the adaptor with the transport container using a retainer coupled between the adaptor and the transport container.

The refill liquid may include a personal care product.

The personal care product may include soap, shampoo, conditioner, or lotion.

In accordance with another aspect of the invention, there is provided an apparatus for delivering refill liquid to a destination container. The apparatus includes a deformable transport container including a nozzle having an outer cylindrical surface having a threaded portion, an adaptor including an inlet, an outlet, and a passage extending between the inlet and the outlet, and a flexible strap coupled between the adaptor and the transport container for retaining the adaptor with the transport container. The inlet is removably receivable in the nozzle, such that when the inlet is received in the nozzle, the inlet is operable to receive a flow of the refill liquid from the transport container through the nozzle and to channel the flow through the passage to the outlet, the outlet being operable to dispense the refill liquid into the destination container, and when the inlet is not received in the nozzle, the transport container is operable to receive the refill liquid through the nozzle. The inlet includes a taper complementary to the nozzle such that the inlet, when received in the nozzle, is retained by a friction fit.

The refill liquid may include a personal care product.

The personal care product may include soap, shampoo, conditioner, or lotion.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a perspective view of a refill apparatus for delivering refill liquid to a destination container according to one embodiment of the invention, wherein the apparatus is in one configuration;

FIG. 2 is a flowchart depicting a process for delivering refill liquid to a destination container according to one embodiment of the invention, using the apparatus shown in FIG. 1;

FIG. 3 is a perspective view of the apparatus of FIG. 1 in another configuration;

FIG. 4 is a perspective view of the apparatus of FIG. 1 in another configuration;

FIG. 5 is a perspective view of the apparatus of FIG. 1 in another configuration;

FIG. 6 is a side cross-sectional view of a system for delivering refill liquid including the apparatus of FIG. 1 in the configuration shown in FIG. 5 in use for refilling a destination container, according to an embodiment of the invention; and

FIG. 7 is a perspective view of a refill apparatus for delivering refill liquid to a destination container according to another embodiment of the invention.

### DETAILED DESCRIPTION

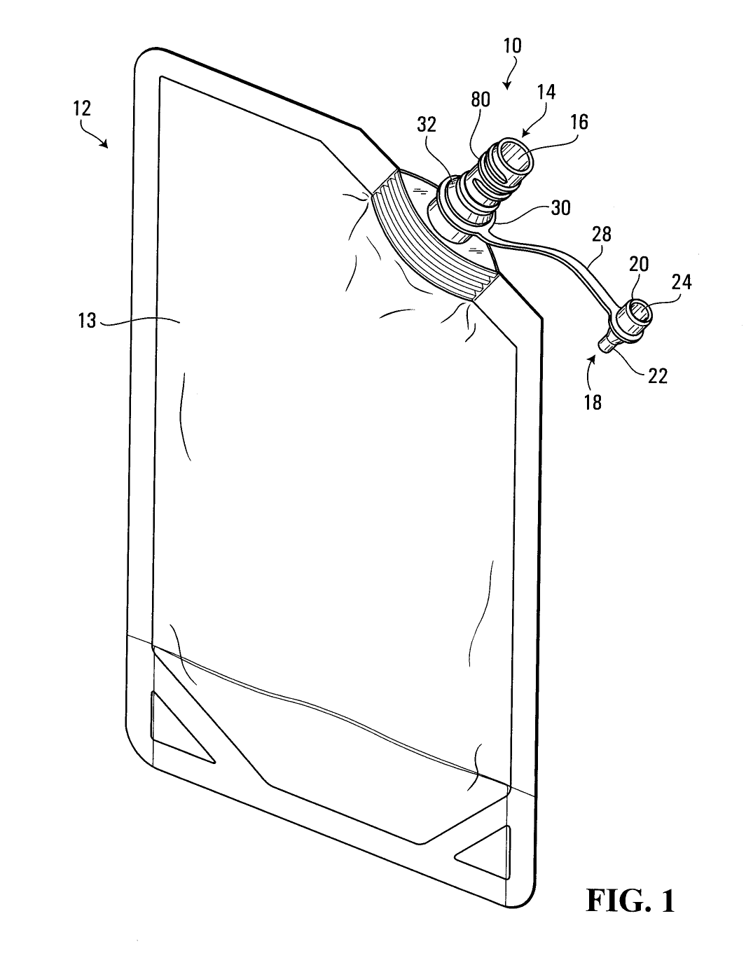

Referring to FIG. 1, a refill apparatus for delivering refill liquid to a destination container according to one embodiment of the invention is shown generally at 10. The refill apparatus 10 includes a transport container 12 and an adaptor 18. The transport container 12 is configured to receive and hold refill liquid during transport from a bulk source to a destination container. In some embodiments, the refill liquid may be a personal care or cosmetic product, such as soap, shampoo, conditioner, or lotion.

The transport container 12 shown in FIG. 1 includes a deformable bag or pouch 13 and a nozzle 14 having an opening 16 for receiving refill liquid.

The deformable bag 13 may be made of a deformable material, such as plastic, configured to hold refill liquid. In some embodiments, the deformability of the deformable bag 13 may facilitate compression of the transport container 12 for storage when not filled with refill liquid. Accordingly, in some embodiments, the transport container 12 may be more easily and cost effectively stored and shipped when compared to non-deformable containers. Further, the deformable bag 13 may be fabricated from less material than would be required to fabricate a more rigid container having comparable volume and thus may be less costly to produce.

In some embodiments, the nozzle 14 may be made of a rigid material, such as plastic. In the embodiment shown, the nozzle 14 includes a threaded portion 80.

The adaptor 18 includes an inlet 20, an outlet 22, and a passage 24 extending between the inlet and the outlet. The inlet 20 is removably receivable at the opening 16. In the configuration shown in FIG. 1, the inlet 20 has not yet been received at the opening 16 and the transport container 12 is thus operable to receive refill liquid through the opening 16. The adaptor 18 may be fabricated from a material that causes the adaptor 18 to be rigid, such as plastic.

In some embodiments, the refill apparatus 10 includes a flexible strap 28 coupled between the adaptor 18 and the transport container 12. The strap 28 acts as a retainer for retaining the adaptor 18 with the transport container 12, when the adaptor 18 is not received in the opening 16. In the embodiment shown, the flexible strap 28 and the adaptor 18 are formed from a unitary body of semi-rigid material, such as for example, plastic. In the embodiment shown, the flexible strap 28 may be sufficiently thin to provide flexibility to the strap 28. In other embodiments, the flexible strap 28 may be separate from the adaptor 18 and may comprise for example, string, or wire. In some embodiments, the flexible strap 28 may be omitted.

The flexible strap 28 includes a loop or annular portion 30 which is configured to rotatably couple to the transport container 12 by encircling the nozzle 14 and being retained by a collar 32 of the nozzle 14. The flexible strap 28 is, thus, rotatably coupled to the transport container 12 such that the adaptor 18 is free to rotate about the opening 16.

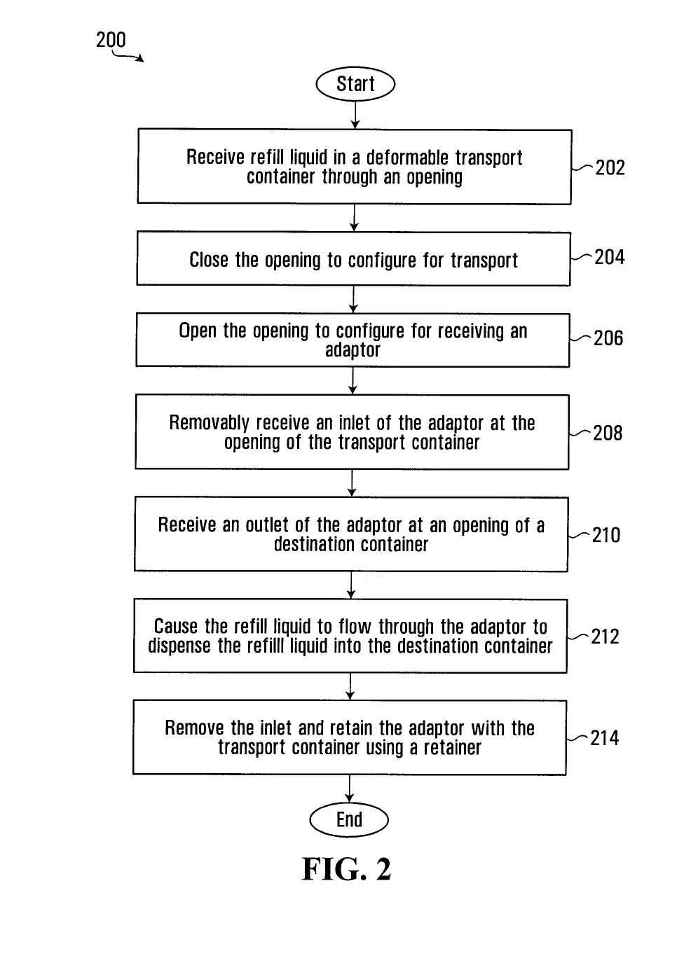

Referring to FIG. 2, a process flowchart for delivering refill liquid to a destination container using the refill apparatus 10, according to one embodiment of the invention, is shown at 200. In various embodiments, blocks depicted in the process 200 may be performed by a customer or user who wishes to refill a personal care product container with refill liquid obtained from a bulk source located, for example, at a hair salon or retail store.

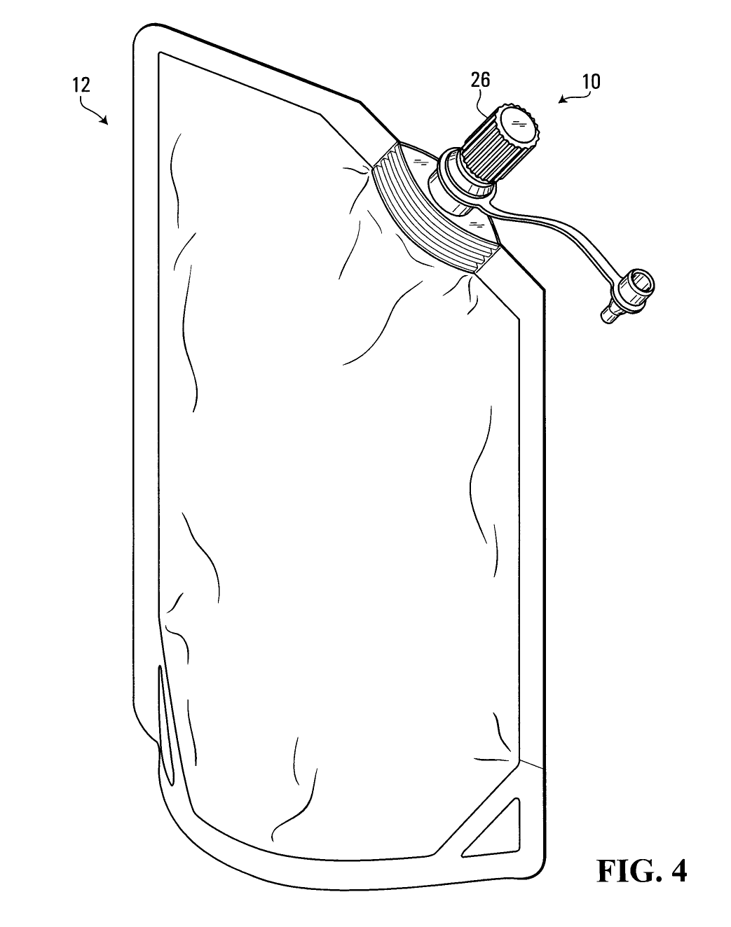

The process 200 begins at block 202, which involves receiving a refill liquid in the transport container 12 through the opening 16 of the transport container. In some embodiments, the opening 16 of the transport container 12 may be large enough to receive a nozzle of a bulk source, which may facilitate easier, spill free, filling. Block 204 involves closing the opening 16 of the transport container 12 to configure the transport container for transport. For example, the user may close the opening 16 with a closure, such as a cap (e.g. cap 26 shown in FIG. 4). Block 204 may also involve transporting the transport container 12 to a destination container that the user intends to fill with the refill liquid. Block 206 then involves opening the opening 16 of the transport container 12 to configure the transport container to receive the inlet 20 of the adaptor 18 at the opening 16. In some embodiments where spillage of the refill liquid is not an issue, such as when the transport container 12 will not be disturbed during transport, or where transport is unnecessary, blocks 204 and 206 may be omitted.

Block 208 involves removably receiving the inlet 20 of the adaptor 18 at the opening 16 of the transport container 12. In some embodiments block 208 involves the user inserting the adaptor 18 into the opening 16. Next, block 210 involves receiving the outlet 22 of the adaptor 18 at an opening of the destination container. In some embodiments, the opening of the destination container may be smaller than the opening of the transport container and the outlet of the adaptor may be configured to fit within the opening of the destination container, which may faciltiate easy, spill free, filling of the destination container. Block 212 involves causing the refill liquid to flow from the opening 16 of the transport container 12 through the passage 24 extending from the inlet 20 to the outlet 22 of the adaptor 18 to dispense the refill liquid into the destination container. Block 214 involves removing the inlet 20 of the adaptor 18 from the opening 16 and retaining the adaptor 18 with the transport container using the retainer 28.

In some embodiments, after completing block 214 the process may return to block 202. Accordingly, in some embodiments, because the adaptor 18 is removable from the opening 16, the transport container 12 may be able to be re-used for multiple iterations of blocks 202-214.

Further, in some embodiments, by using the above process, which employs an adaptor, a user may be able to quickly fill a transport container through a relatively large opening and to dispense from the transport container into a small opening in a destination container by dispensing the refill liquid through a relatively small outlet of an adaptor configured to be received in the opening of the destination container.

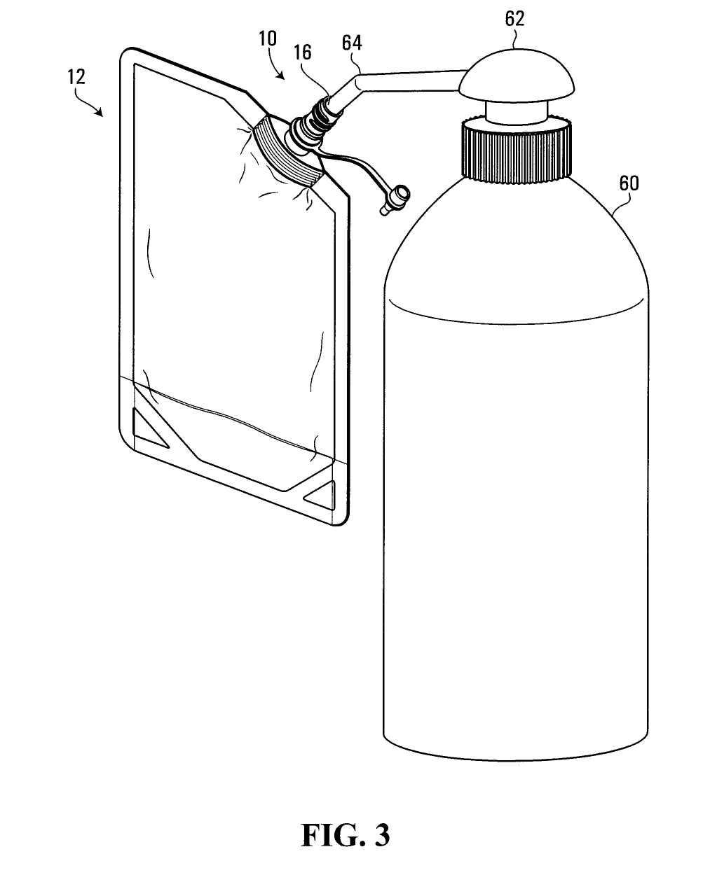

Below, with reference to FIGS. 3-6, the refill apparatus 10 shown in FIG. 1 is described in further detail having regard to its use in a process similar to that described in the process 200 shown in FIG. 2.

Referring to FIG. 3, the transport container 12 of the refill apparatus 10 is shown receiving refill liquid through the opening 16, as described in block 202 shown in FIG. 2. In the embodiment shown, the transport container 12 receives the refill liquid through the opening 16 from a bulk source 60 having a pump 62 and a nozzle 64.

In the embodiment shown in FIG. 3, the nozzle 64 of the bulk source 60 containing the refill liquid has been received in the opening 16. A user may engage the pump 62 of the bulk source 60 to cause refill liquid to be pumped into the transport container 12 through the opening 16.

The opening 16 may be sized large enough to accommodate receiving the nozzle 64 therewithin and the nozzle 64 may be sized large enough to allow the refill liquid to be pumped into the transport container 12 within about 1 minute. In one embodiment, the opening 16 has a diameter of about 0.385 inches and the nozzle 64 has an outer diameter of about 0.3 inches and an inner passage having a diameter of about 0.25 inches. In other embodiments, the opening 16 may be sized differently and/or the nozzle 64 may be sized differently. In some embodiments, the diameter of the opening 16 may correspond to a capacity of the transport container 12. For example, in the embodiment shown, the transport container 12 has a capacity of about 350 mL and the diameter of the opening 16 is about 11 mm. In some embodiments, the diameter of the opening 16 may differ. For example, in various embodiments, the transport container 12 may be configured to hold about 1 L and the diameter of the opening 16 may be about 22 mm, for example.

In some embodiments, because the nozzle 64 is receivable within the opening 16, a user may be able to pump the refill liquid into the transport container 12 without risking spillage of the refill liquid.

In some embodiments, the bulk source 60 may include a hand pump, a foot pump, a powered pump such as an electric pump, vacuum pump, or any other type of pump.

The transport container 12 may deform while being filled to accommodate refill liquid as it is pumped into the transport container, as shown in FIG. 4. In some embodiments, a capacity of the transport container 12 corresponds to a capacity of the destination container that is to be filled. For example, in one embodiment, where the destination container is capable of holding 350 ml of refill liquid, the transport container 12 may be correspondingly configured to also hold about 350 ml of refill liquid thus providing a single refill for the destination container. In other embodiments, the transport container 12 may be configured to hold any other volume of refill liquid that may correspond to a capacity of the destination container that is to be filled. For example, in various embodiments, the transport container 12 may be configured to hold about 200 mL, 350 mL, 500 mL, 750 mL, or 1 L of fluid.

Once the transport container 12 is filled with the refill liquid, the transport container 12 may be configured for transport by closing the opening 16 using a closure, as per block 204 of the process 200 shown in FIG. 2. In the embodiment shown in FIG. 4, the opening 16 of the refill apparatus 10 has been closed using the cap 26, which includes a threaded portion that is complementary to the threaded portion 80 of the nozzle 14 (see FIG. 1). The threaded portion 80 is configured to threadably receive the cap 26 by engaging the threaded portion of the cap 26 and thereby retaining the cap 26 on the nozzle 14 over the opening 16, such that the cap 26 is configured to sealably and reversibly close the opening 16.

The refill apparatus 10 may be transported, in the configuration shown in FIG. 4, from a location having the bulk source 60 (such as a retail store or hair salon), to a location where a destination container for receiving the refill liquid is located (such as the user's home).

In one embodiment, after transporting, and once a user is ready to dispense the refill liquid from the transport container 12, the user may configure the transport container to receive the inlet 20 of the adaptor 18 by removing the cap 26 from the nozzle 14 to re-open the opening 16 as described in block 206 shown in FIG. 2, such that the refill apparatus 10 is in a configuration generally similar to that shown in FIG. 1.

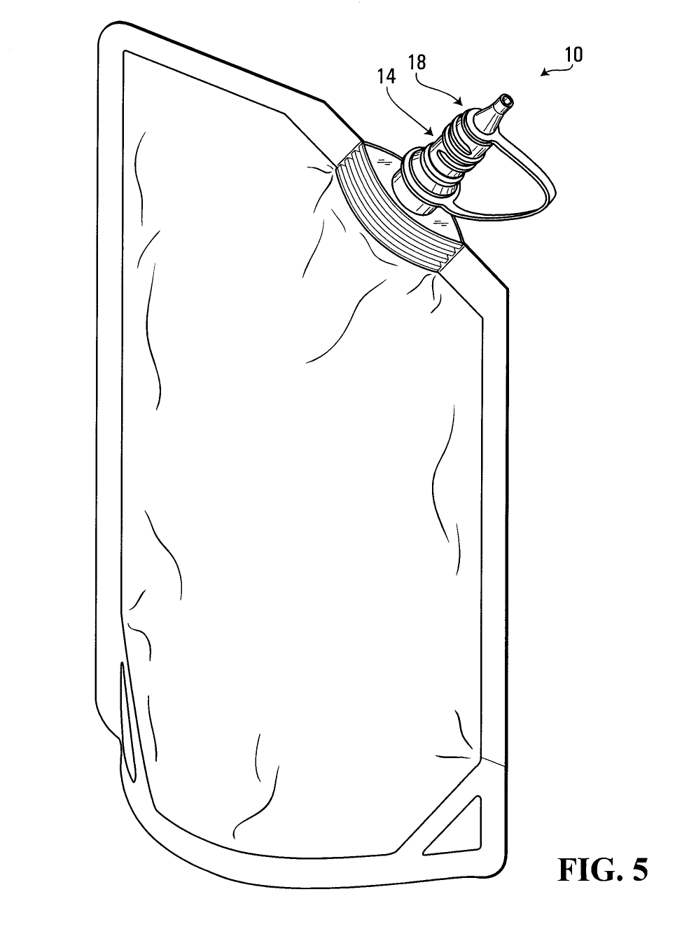

The user may then cause the inlet 20 of the adaptor 18 to be removably received at the opening 16, as described at block 208 of the process 200 shown in FIG. 2. In the embodiment shown in FIG. 5, the user has inserted the inlet 20 of the adaptor 18 into the opening 16 such that the refill apparatus 10 is in the configuration shown.

In other embodiments, an inlet of an adaptor may be received at the opening 16 in other ways. For example, an inlet of an adaptor may have an inner diameter that corresponds to the outer diameter of the nozzle 14 and the inlet may be received at the opening 16 by being placed on the nozzle 14. In some embodiments, an adaptor may included a threaded portion that corresponds to and engages with the threaded portion 80 of the nozzle when the adaptor is received at the opening 16. However, in some embodiments, sizing the inlet 20 to fit within the opening 16 may allow the adaptor 18 to be smaller and thus may provide reduced costs compared to embodiments where the inlet 20 is sized to surround the nozzle 14.

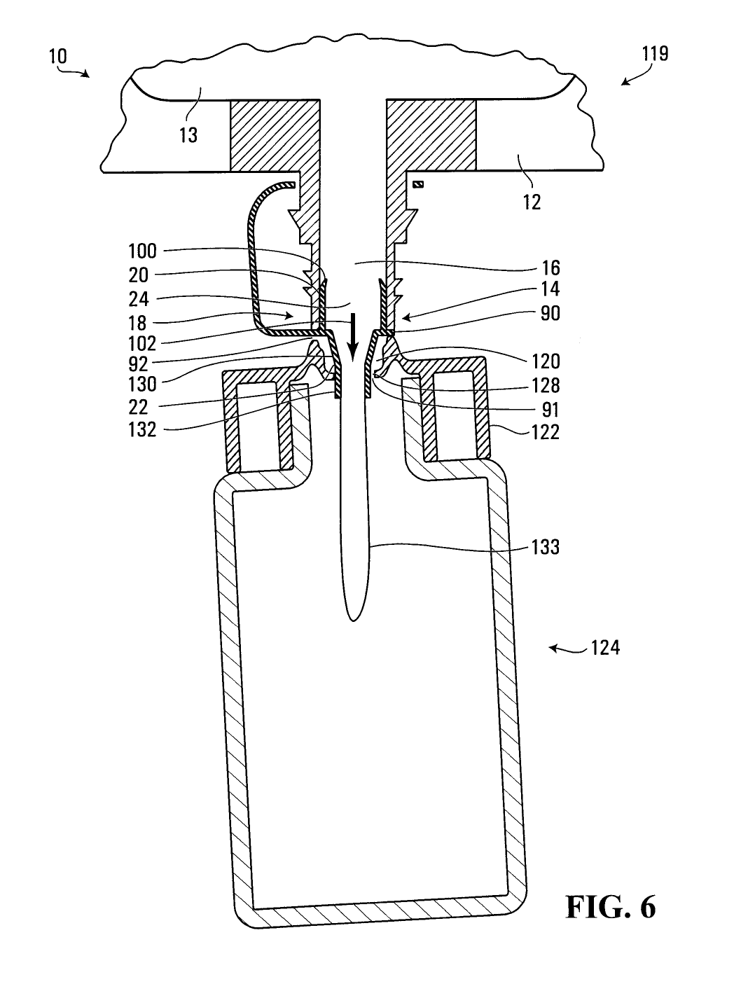

FIG. 6 shows a system 119 for delivering refill liquid according to one embodiment, including the refill apparatus 10 and a destination container 124. FIG. 6 shows a cross sectional view of a portion of the refill apparatus 10 in the configuration shown in FIG. 5 with the outlet 22 of the adaptor 18 received in an opening 120 of a cap 122 of the destination container 124.

In the embodiment shown, the inlet 20 includes a tapered portion 100, complementary to the opening 16 that has an outer diameter that widens to a diameter about equal to a diameter of the opening 16. In one embodiment, to insert the inlet 20 of the adaptor 18 into the opening 16, a user may push the tapered portion 100 into the opening 16 such that the inlet 20, when received in the opening 16 is retained by a friction fit within the opening 16. For example, in one embodiment, the tapered portion 100 may allow the user to more easily centre the inlet 20 when inserting the inlet 20 into the friction fit within the opening 16.

In the embodiment shown, the adaptor 18 includes a flange 90 configured and disposed to abut the nozzle 14 when the inlet 20 is received at the opening 16 of the transport container 12 and thereby limit the depth to which the inlet 20 can be inserted into the opening 16. In the embodiment shown, the flange 90 comprises a ring that encircles the passage 24 and is disposed between the inlet 20 and the outlet 22. In some embodiments, the flange 90 may have an outer diameter at least as large as the outer diameter of the nozzle 14 and, thus, be configured to be gripped by a user when the user wishes to remove the adaptor 18 from the opening 16.

With the inlet 20 removably received in the opening 16, the inlet 20 is operable to receive a flow of refill liquid through the opening 16 from the transport container 12 and to channel the flow through the passage 24 to the outlet 22, as shown by arrow 102 shown in FIG. 6. In the embodiment shown in FIG. 6, the outlet is operable to dispense the refill liquid into the destination container 124.

In the embodiment shown, before causing the refill liquid to flow through the adaptor 18, the outlet 22 of the adaptor 18 has been removably received at the opening 120 of the cap 122 of the destination container 124, as described in block 210 of the process 200 shown in FIG. 2. In the embodiment shown in FIG. 6, the outlet 22 has been removably received within the opening 120.

The cap 122 of the destination container 124 defines the opening 120 which narrows to a narrow portion 128. The outlet 22 includes a frustoconical portion 130 and a cylindrically shaped extension 132 extending therefrom. In the embodiment shown, the extension 132 has been inserted through the narrow portion 128 of the opening 120 such that the extension 132 extends past the narrow portion of 128 of the opening 120 into the destination container 124.

The cylindrical shape of the extension 132 may facilitate the extension extending past the narrow portion 128 of the opening 120, while retaining the same diameter of the passage 24. The ability of the extension 132 to extend into the narrow portion 128 of the opening 120 may result in the extension being less likely to slip out of the narrow portion 128 of the opening 120 during filling of the destination container 124. Keeping the same diameter as the extension 132 extends past the narrow portion 128 of the opening 120 may allow for refill liquid to flow more quickly and easily through the passage 24.

In the embodiment shown in FIG. 6, the outlet 22 has been inserted into the opening 120 to a depth where the flange 90 abuts a collar of the cap 122 surrounding the opening 120. The flange 90 acts as stopper for limiting the depth to which the adaptor 18 can be inserted into the opening 120. As shown in FIG. 6, the flange 90 is configured to abut the collar of the cap 122 before the frustoconical portion 130 of the outlet 22 reaches the narrow portion 128 of the opening 120. Thus, in the embodiment shown in FIG. 6, the frustoconical portion 130 of the outlet 22 may not seal against the cap 122 in the opening 120 and only the extension 132 is able to pass through the narrow portion 128 of the opening 120.

The extension 132 has an outer diameter that is smaller than a diameter of the opening 120 such that a gap 91 is formed between the extension 132 and the cap 122 at the narrow portion 128 of the opening 120 when the extension 132 is received therein.

Further, in the embodiment shown in FIG. 6, the adaptor 18 fits loosely into the opening 120, and the flange 90 is angled at least slightly when abutting the collar of the cap 122, such that a gap 92 is formed between the flange 90 and the collar of the cap 122, on one side of the flange 90.

In the embodiment shown, the gaps 91 and 92 may allow air that is displaced by refill liquid being dispensed into the destination container 124 to flow out of the destination container 124. Accordingly, the gaps 91 and 92 may allow for quick filling of the destination container 124.

After the outlet 22 has been received in the opening 120 of the cap 122 of the destination container 124, a user may cause refill liquid 133 to be channeled from the opening 16 of the transport container 12 through the passage 24 to the outlet 22 of the adaptor 18 and into the destination container 124, as described in block 212 of the process 200 shown in FIG. 2, and as shown in FIG. 6.

In one embodiment, the user may cause the refill liquid to be channeled from the opening 16 of the transport container 12 through the passage 24 to the outlet 22 of the adaptor 18 by squeezing the deformable bag 13 to force the refill liquid to flow in the direction shown by the arrow 102.

Once the destination container 124 is filled, or when no more refill liquid can be dispensed from the transport container 12, the user may remove the adaptor 18 from the opening 16 and clean the adaptor 18 and/or the transport container 12. In some embodiments, the rotatable connection of the flexible strap 28 may facilitate rotation of the adaptor 18 about the transport container 12 to help disconnect the adaptor 18 from the opening 16, when the user wishes to remove the adaptor 18 from the opening 16.

When the user is ready to fill another destination container or to refill the destination container 124, the user may return to block 202 of the process 200 shown in FIG. 2.

In some embodiments, where some refill liquid remains in the transport container 12 after completing block 214 of the process 200 shown in FIG. 2, the user may replace the cap 26 on the nozzle 14 (generally as shown in FIG. 4) and store the transport container 12. The user may then return to block 202 or 206 of the process 200 shown in FIG. 2 at a later time.

Still referring to FIG. 6, in some embodiments, the deformable bag 13 may be sized and configured such that pressure created in the refill liquid by squeezing the deformable bag 13 is low enough such that a force on the inlet 20 resulting from the pressure cannot overcome a friction force provided by the friction fit retaining the inlet 20 within the opening 16 and thus the friction fit is sufficient to retain the adaptor 18 in the opening 16 during refilling.

In some embodiments, use of the friction fit may allow a user to quickly insert and remove the inlet 18 from the opening 16. Further the friction fit may allow the inlet 20 and the opening 16 to be generally smooth, which may allow for ease of cleaning. This may be particularly important when the refill liquid is a personal care product that must be kept clean and free of contamination. In some embodiments, using a friction fit may allow for lower manufacturing costs than with other connections for retaining the inlet 18 in the opening 16.

In other embodiments, the inlet 20 may be retained in the opening 16 by another means, such as by a threaded connection or by a snap fit connection. A threaded connection or a snap fit connection may be preferred in embodiments where a pressure in the refill liquid during refilling results in a force on the inlet 20 that could overcome the friction force of the friction fit retaining the inlet 20 within the opening 16.

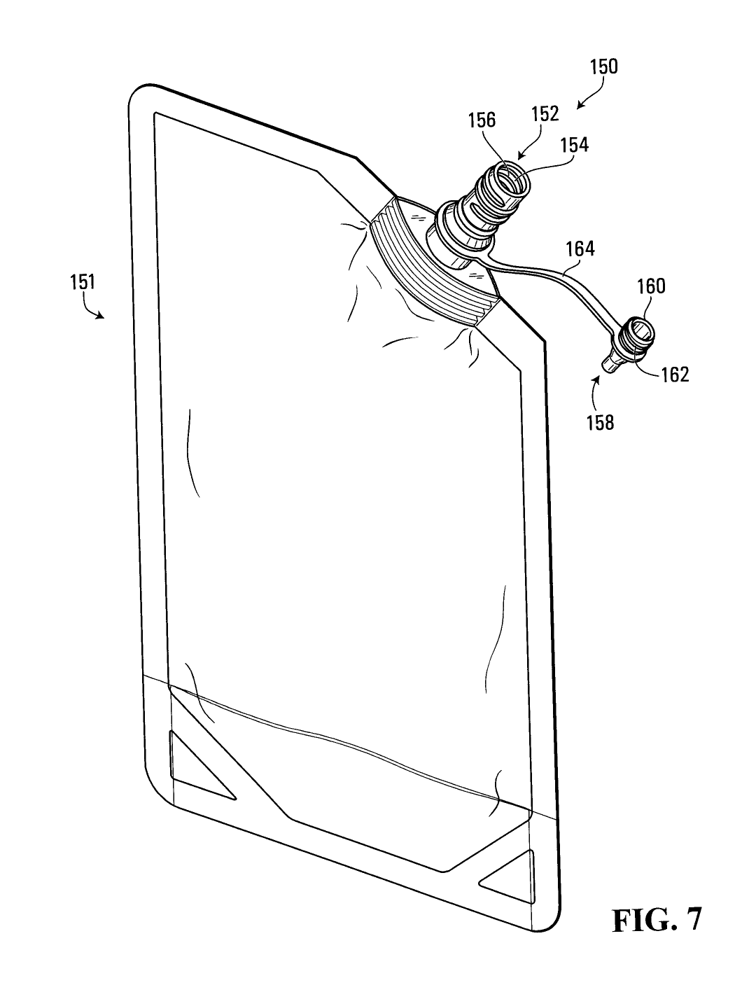

In FIG. 7, a refill apparatus for delivering refill liquid to a destination container according to another embodiment of the invention is shown generally at 150. The refill apparatus 150 is generally similar to the refill apparatus 10. The refill apparatus 150 includes a transport container 151 and an adaptor 158. The transport container 151 includes a nozzle 152, having an opening 154, which is generally similar to the nozzle 14 shown in FIGS. 1 and 3-6 except that the nozzle 152 includes an internal threaded portion 156. The adaptor 158 is generally similar to the adaptor 18 shown in FIGS. 1 and 3-6 except that the adaptor 158 includes an inlet 160 having a threaded portion 162 complementary to the internal threaded portion 156 of the nozzle 152.

In the embodiment shown in FIG. 7, the threaded portion 156 is configured to threadably receive the threaded portion 162 of the inlet 160 such that the threaded portions 156 and 162 cooperate to removably retain the inlet 160 within the opening 154. In some embodiments, the threaded portions 156 and 162 may provide a stronger connection than a friction fit.

In the embodiment shown, the refill apparatus 150 also includes a flexible strap 164 generally similar to the flexible strap 28 shown in FIG. 1. In some embodiments, the rotatable connection of the flexible strap 164 to the transport container 151 may facilitate rotation of the adaptor 158 about the transport container to engage or disengage the threaded portions 156 and 162 and thus connect or disconnect the adaptor 158 from the opening 156.

While specific embodiments of the invention have been described and illustrated, such embodiments should be considered illustrative of the invention only and not as limiting the invention as construed in accordance with the accompanying claims.

1. An apparatus for delivering refill liquid to a destination container, the apparatus comprising:
a deformable transport container having an opening for receiving the refill liquid; and
an adaptor comprising an inlet, an outlet, and a passage extending between the inlet and the outlet;
wherein the inlet is removably receivable at the opening of the transport container such that when the inlet is received at the opening, the inlet is operable to receive a flow of the refill liquid through the opening from the transport container and to channel the flow through the passage to the outlet, the outlet being operable to dispense the refill liquid into the destination container, and when the inlet is not received at the opening, the transport container is operable to receive the refill liquid through the opening.

2. The apparatus of claim 1 further comprising a retainer coupled between the adaptor and the transport container for retaining the adaptor with the transport container.

3. The apparatus of claim 2 wherein the retainer comprises a flexible strap.

4. The apparatus of claim 3 wherein the flexible strap is rotatably coupled to the transport container such that the adaptor is free to rotate about the opening.

5. The apparatus of claim 1 wherein the inlet is removably receivable within the opening of the transport container.

6. The apparatus of claim 5 wherein the inlet comprises a taper complementary to the opening of the transport container such that the inlet, when received in the opening, is retained by a friction fit between the inlet and the transport container.

7. The apparatus of claim 1 wherein the inlet includes a threaded portion and the transport container comprises a threaded portion complementary to the threaded portion of the inlet, the threaded portion of the transport container being configured to threadably receive the inlet at the opening.

8. The apparatus of claim 1 wherein the adaptor further comprises a flange adjacent the inlet and disposed to abut at least a portion of the transport container when the inlet is received at the opening of the transport container.

9. The apparatus of claim 8 wherein the flange comprises a ring encircling the passage.

10. The apparatus claim 1 wherein the outlet is removably receivable in the opening of the destination container.

11. The apparatus of claim 10 wherein the outlet is configured to form a gap between the outlet and the destination container at the opening of the destination container when the outlet is received in the opening of the destination container.

12. The apparatus of claim 11 wherein the adaptor further comprises a flange adjacent the outlet and disposed to abut at least a portion of the destination container at the opening of the destination container when the outlet is received in the opening of the destination container.

13. The apparatus of claim 1 wherein the outlet comprises a frustoconical portion.

14. The apparatus of claim 13 wherein the outlet comprises a cylindrical portion extending from the frustoconical portion.

15. The apparatus of claim 1 wherein the transport container is configured to receive a closure for closing the opening.

16. The apparatus of claim 15 wherein the closure comprises a cap.

17. The apparatus of claim 16 wherein the cap comprises a threaded portion and wherein the transport container comprises a complementary threaded portion for threadably receiving the cap.

18. The apparatus of claim 1 wherein the transport container comprises a plastic bag.

19. The apparatus of claim 1 wherein the refill liquid comprises a personal care product.

20. The apparatus of claim 19 wherein the personal care product comprises:
soap;
shampoo;
conditioner; or
lotion.

21. A system for delivering refill liquid comprising:
the apparatus of claim 1; and
the destination container.

22. The system of claim 21 wherein the destination container comprises a personal care product container.

23. The system of claim 22 wherein the personal care product container is operable to hold the refill liquid.

24. A method of delivering refill liquid to a destination container, the method comprising:
receiving the refill liquid in a deformable transport container through an opening of the transport container;
configuring the transport container for transport by closing the opening of the transport container;
configuring the transport container to receive an inlet of an adaptor at the opening by opening the opening;
removably receiving the inlet of the adaptor at the opening of the transport container;
receiving an outlet of the adaptor at an opening of the destination container;
causing the refill liquid to flow from the opening of the transport container through a passage extending from the inlet to the outlet of the adaptor to dispense the refill liquid into the destination container.

25. The method of claim 24 further comprising removing the inlet from the opening of the transport container and retaining the adaptor with the transport container using a retainer coupled between the adaptor and the transport container.

26. The apparatus of claim 24 wherein the refill liquid comprises a personal care product.

27. The apparatus of claim 26 wherein the personal care product comprises:
soap;
shampoo;
conditioner; or
lotion.

28. An apparatus for delivering refill liquid to a destination container, the apparatus comprising:
a deformable transport container including a nozzle having an outer cylindrical surface having a threaded portion;
an adaptor comprising an inlet, an outlet, and a passage extending between the inlet and the outlet; and
a flexible strap coupled between the adaptor and the transport container for retaining the adaptor with the transport container;
wherein the inlet is removably receivable in the nozzle, such that when the inlet is received in the nozzle, the inlet is operable to receive a flow of the refill liquid from the transport container through the nozzle and to channel the flow through the passage to the outlet, the outlet being operable to dispense the refill liquid into the destination container, and when the inlet is not received in the nozzle, the transport container is operable to receive the refill liquid through the nozzle;
wherein the inlet includes a taper complementary to the nozzle such that the inlet, when received in the nozzle, is retained by a friction fit.

29. The apparatus of claim 28 wherein the refill liquid comprises a personal care product.

30. The apparatus of claim 29 wherein the personal care product comprises:
soap;
shampoo;
conditioner; or
lotion.
